(19) United States
(12) Patent Application Publication
(10) Pub. No.: US 2004/0025940 A1
(43) Pub. Date: Feb. 12, 2004

(54) Balance switch for controlling gas

(75) Inventors: Tse-Lun Chang, Tao-Yuan (TW); Wen-Ming Chen, Maio-Li (TW)

Correspondence Address: LOWE HAUPTMAN GILMAN & BERNER, LLP, Suite 310, 1700 Diagonal Road, Alexandria, VA, 22314, US

(73) Assignee: Taiwan Semiconductor Manufacturing Co., Ltd.

(21) Appl. No.: 10/212,233

(22) Filed: Aug. 6, 2002

(51) Int. Cl. G05D 7/06

(52) U.S. Cl. 137/487.5

(57) ABSTRACT

A pressure switch device for controlling gas without calibration of pressure in a vacuum system is disclosed. The pressure switch device comprises an isolation valve for controlling gas flow between a chamber and a pump, a pressure balance switch bypassing said isolation valve and detecting a pressure difference between the chamber and the pump, and a control line used by said pressure balance switch to control said isolation valve, wherein said pressure balance switch open said isolation valve whenever the pressure difference between the chamber and the pump is larger than a predetermined value.

### BACKGROUND OF THE INVENTION

1. Field of the Invention

The present invention generally relates to a pressure switch a vacuum system, and more particularly to pressure balance switches of a vacuum system without any calibration of the pressures.

2. Description of the Prior Art

In a conventional vacuum system, a plurality of manometers are utilized in order to separately detect pressures in different portions of the vacuum system and maintain vacuum condition of the vacuum system. However, since the pressure in each portion of the vacuum system usually would not be identical and the detecting range of each manometer is not necessarily the same, the pressure may exceed the detecting range of some manometer and render the vacuum system dangerous when gates or valves isolating portions are open.

FIG. 1 shows a conventional vacuum system. The vacuum system has an isolation valve 11, a pipe 12, a chamber 13, a pump 14, and manometers 15 and 16. The pipe 12 connects the pump 14 and the chamber 13. The pump 14 and the chamber 13 are isolated and linked by the isolation valve 11. The manometer 15 is used to detect the pressure in the chamber 13 and the manometer 16 is used to detect the pressure in the pipe 12 of the pump side. The vacuum condition of the chamber 12 is maintained by the open/close of the isolation valve 11 and the pumping of the pump 14. In operation, the isolation valve is closed when the pressure in the chamber 13 detected by the manometer 15 is lower the pressure in the pipe 12 of the pump side detected by the manometer 16. The isolation valve is open when the pressure in the chamber 13 detected by the manometer 15 is larger the pressure in the pipe 12 of the pump side detected by the manometer 16 and the pump 14 pumps out gas in the chamber 13.

However, the vacuum system set forth has some drawbacks. For example, since the detecting ranges of the manometers 15 and 16 may be different, the pressure either in the chamber 13 or the pipe 12 of the pump side may exceed the detecting ranges of the manometers 15 and 16 and render the vacuum system dangerous when the isolation valve 11 is open.

In view of the drawbacks mentioned with the prior art system, there is a continued need to develop new and improved systems that overcome the disadvantages associated with prior art system. The advantages of this invention are that it solves the problems mentioned above.

### SUMMARY OF THE INVENTION

It is therefore an object of the invention to provide a pressure switch adapted in a vacuum system to control an isolation valve of the vacuum system and provide a balanced pressure when two portions of the vacuum system are connected.

It is another object of the invention to provide an automatic control of an isolation valve and automatic maintenance of vacuum condition of a chamber without any calibration of the pressures separately in the chamber and the pipe of the pump side.

To achieve these objects, and in accordance with the purpose of the invention, the invention provide a pressure switch device for controlling gas without calibration of pressure in a vacuum system, said pressure switch device comprises an isolation valve for controlling gas flow between a chamber and a pump, a pressure balance switch bypassing said isolation valve and detecting a pressure difference between the chamber and the pump, and a control line used by said pressure balance switch to control said isolation valve, wherein said pressure balance switch open said isolation valve whenever the pressure difference between the chamber and the pump is larger than a predetermined value.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates the conventional vacuum system;

FIG. 2 illustrates the conventional vacuum system of the present invention;

FIGS. 3A and 3B show how the pressure balance switch of the invention operates; and

FIGS. 4 and 5 show how the pressure balance switch of the invention operates when the pressure switch is adapted in a vacuum system.

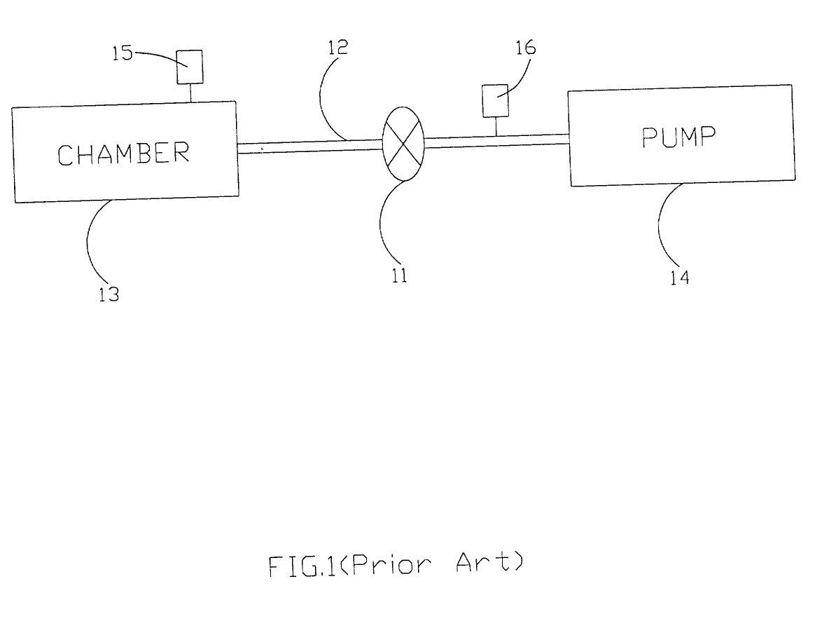

### DESCRIPTION OF THE PREFERRED EMBODIMENT

It is to be understood and appreciated that the system and method described below do not cover a complete system and method. The present invention can be practiced in conjunction with various hardware that are used in the art, and only so much of the commonly practiced components and steps are included herein as are necessary to provide an understanding of the present invention.

The present invention will be described in detail with reference to the accompanying drawings. It should be noted that the drawings are in greatly simplified form.

The pressure switch, of present invention is applied to a broad range of vacuum system and can be assembled from a variety of the vacuum system. The following description discusses a preferred embodiment of the pressure switch of the present invention in a vacuum system. The present invention may also be employed in a common factory, and particularly a semiconductor factory. Accordingly, application of the present invention is not intended to be limited to those devices fabricated in semiconductor materials, but will include those devices fabricated in one or more of the available semiconductor materials. Moreover, while the present invention is illustrated by a preferred embodiments directed to pressure switch, it is not intended that these illustrations be a limitation on the scope or applicability of the present invention.

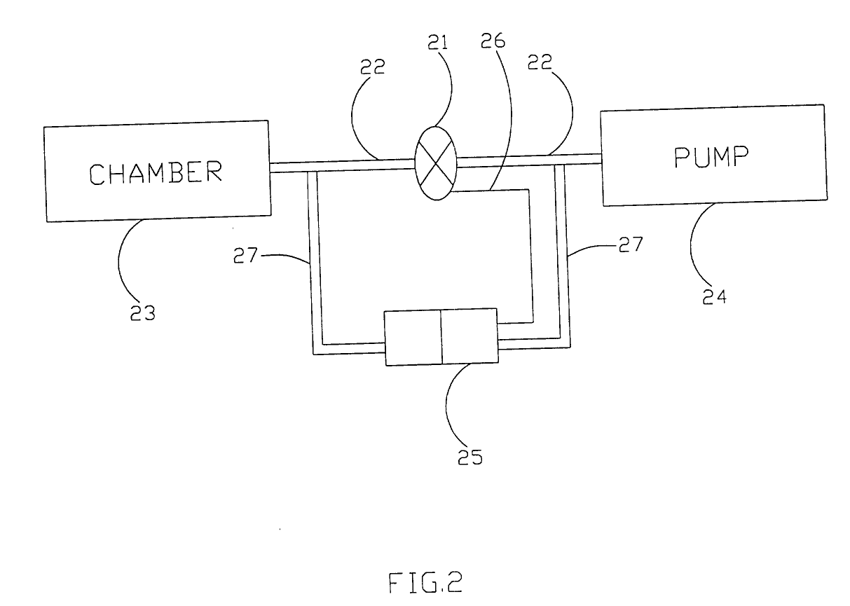

Referring to FIG. 2, a vacuum system having an isolation valve 21, a pipe 22, a chamber 23, a pump 24, a pressure balance switch 25, a control line 26 and a bypass pipe 27 is shown. The pump 24 provides the chamber 23 with a vacuum condition via pumping out the gas in the chamber 23. The pipe 22 connects the pump 24 and the chamber 23 when the isolation valve 21 is open. The pipe 22 and the pump 24 and the chamber 23 are disconnected when the isolation valve 21 is closed. The pump 24 and the chamber 23 are also isolated or connected by the pressure balance switch 25 and the bypass pipe 27. The control line 26 connects the pressure balance switch 25 and the isolation valve 21. The pressure balance switch 25 is used to automatically compare the pressures separately in the chamber 23 and the pipe of the pump side. In another word, the pressure balance switch 25 acts as a pressure difference detector to control the isolation valve 21 by the control line 26. When the pressure difference between the chamber 23 and the pipe of the pump side is over a predetermined value, the pressure switch 25 opens the isolation valve 21.

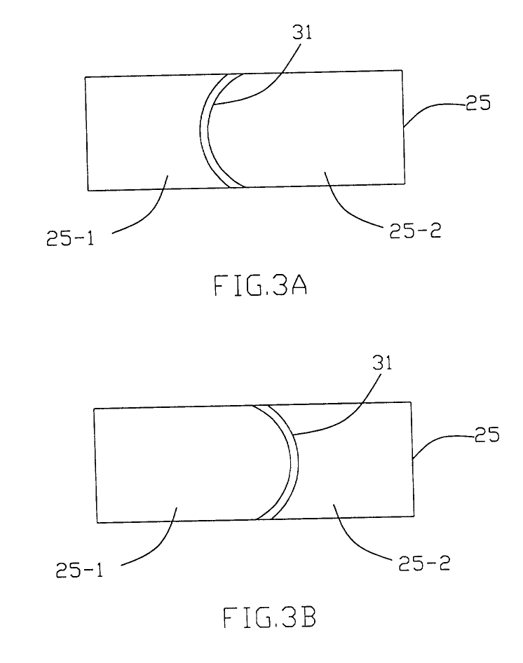

FIGS. 3A and 3B show how the pressure balance switch 25 operates and render the isolation valve 21 opened/closed. The pressure balance switch 25 has a membrane 31 inside. The membrane 31 divides the pressure balance switch 25 into rooms 25-1 and 25-2. The rooms 25-1 and 25-2 separately connect to the chamber 23 and the pump 24 via the bypass pipe 27. Hence the pressures separately in the rooms 25-1 and 25-2 are the same as the pressures in the chamber 23 and the pipe of the pump side. The pressure difference between the chamber 23 and the pipe of the pump side thus would force the membrane 31 to deform or bend. The pressure balance switch 25 therefore can utilize the deformation of the membrane 31 to recognize the pressure difference between the chamber 23 and the pipe of the pump side. As shown in FIG. 3A, when the pressure in room 25-1 is lower than the pressure in room 25-2, the membrane 31 is bent toward the room 25-1. The membrane 31 is bent toward the room 252 when the pressure in room 25-1 is larger than the pressure in room 25-2 as shown in FIG. 3B. The pressure balance switch 25 controls the isolation valve 21 to open/close via the control line 26 according to the deformation of the membrane 31 induced by the pressure difference between the chamber 23 and the pipe of the pump side. The pressure balance switch 25 comprises a membrane manometer. Nevertheless, other membrane manometers in accordance with the invention can also be used. It is known that the pressure balance switch 25 can also use other device to detect and respond the pressure difference between the chamber 23 and the pump 24 and utilizes the device to open the isolation valve 21 whenever the pressure difference between the chamber 23 and the pump 24 is larger than a predetermined value.

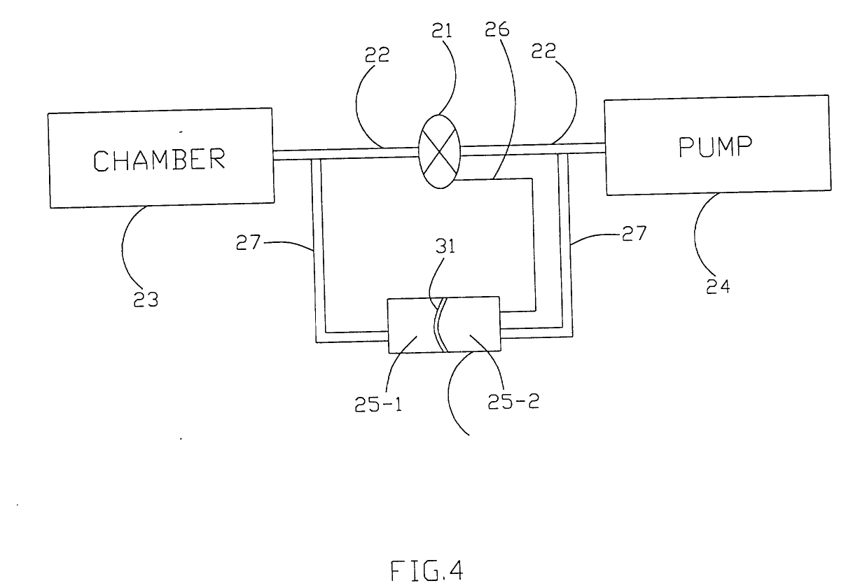

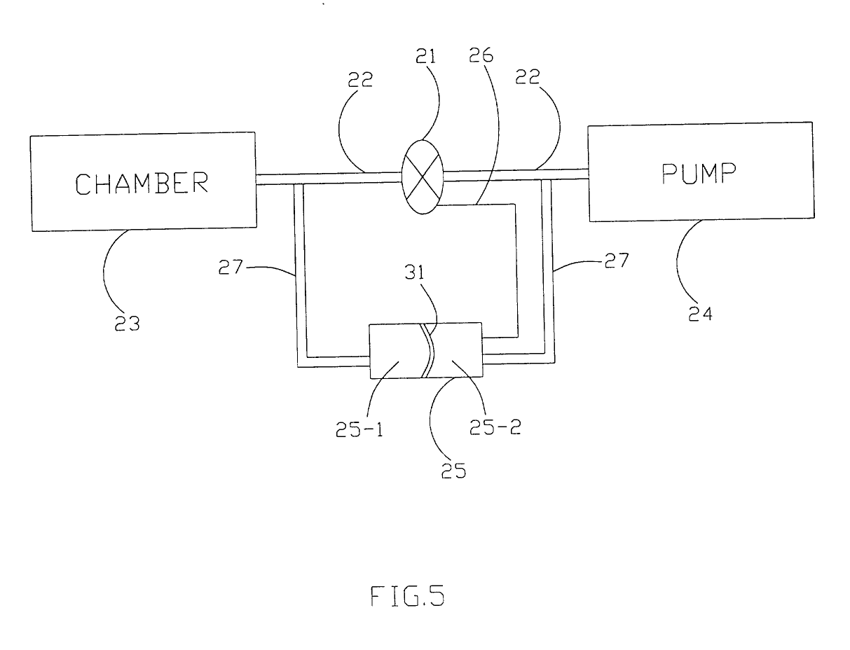

FIGS. 4 and 5 show how the pressure balance switch 25 operates when the pressure balance switch 25 is adapted in a vacuum system. The rooms 25-1 and 25-2 are separately connected to the chamber 23 and the pump 24. As shown in FIG. 4, when the pressure in the chamber 23 is lower than the pressure in the pipe of the pump side, the membrane 31 is forced to bend toward the room 25-1, and the isolation valve 21 is closed. The membrane 31 is forced to bend toward the room 25-2 as the pressure in the chamber 23 is larger than the pressure in the pipe of the pump side, and the isolation valve 21 is opened as shown in FIG. 5. When the isolation valve 21 is opened, the pump 24 pumps out the gas in the chamber 23 through the pipe 22. The invention utilizes the automatic deformation of the membrane 31 induced by the pressure difference between the chamber 23 and the pipe of the pump, side to control the open/closure of the isolation valve 21 without any calibration of the pressures separately in the chamber 23 and the pipe of the pump side. That is, no manometers are needed to be used separately on the chamber 23 and the pipe of the pump side. The isolation valve 21 can be opened when a predetermined pressure difference between the chamber 23 and the pipe of the pump side is achieved. This predetermined pressure difference or threshold pressure difference can be adjusted by the membrane 31. The deformation of the membrane 31 is used to control the isolation valve 21 via the control line 26. The pressure balance switch 25 can control the isolation valve 21 via the control line 26 by a mechanical manner, an electronic manner, a hydraulic manner and a pneumatic way.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A pressure switch device for controlling gas without calibration of pressure in a vacuum system, said pressure switch device comprising:
an isolation valve for controlling gas flow between a chamber and a pump;
a pressure balance switch bypassing said isolation valve and detecting a pressure difference between the chamber and the pump, wherein said pressure balance switch open said isolation valve whenever the pressure difference between the chamber and the pump is larger than a predetermined value; and
a control line used by said pressure balance switch to control said isolation valve.

2. The pressure switch device according to claim 1, wherein said pressure balance switch utilizes a membrane to detect and respond the pressure difference between the chamber and the pump.

3. The pressure switch device according to claim 1, wherein said pressure balance switch controls said isolation valve by a mechanical manner.

4. The pressure switch device according to claim 1, wherein said pressure balance switch controls said isolation valve by an electronic manner.

5. The pressure switch device according to claim 1, wherein said pressure balance switch controls said isolation valve by a hydraulic manner.

6. The pressure switch device according to claim 1, wherein said pressure balance switch controls said isolation valve by a pneumatic way.

7. A pressure switch device for controlling gas without calibration of pressure in a vacuum system, said pressure switch device comprising:
an isolation valve for controlling gas flow between a chamber and a pump;
a pressure balance switch bypassing said isolation valve and detecting and responding a pressure difference between the chamber and the pump by a membrane, wherein said pressure balance switch utilizes deformations of said membrane to open said isolation valve whenever the pressure difference between the chamber and the pump is larger than a predetermined value; and
a control line used by said pressure balance switch to control said isolation valve.
